(19) United States
(12) Patent Application Publication
(10) Pub. No.: US 2016/0068287 A1
(43) Pub. Date: Mar. 10, 2016

(54) Strapping Assembly

(71) Applicant: Terry Gannon, Jr., Penn Valley, CA (US)

(72) Inventor: Terry Gannon, Jr., Penn Valley, CA (US)

(21) Appl. No.: 14/478,161

(22) Filed: Sep. 5, 2014

(51) Int. Cl. B65B 13/34; B25C 5/15; B65B 13/02

(52) U.S. Cl. CPC B65B 13/345; B65B 13/025; B25C 5/15

(57) ABSTRACT

A strapping assembly for fastening a strap to a support surface includes a handle may be gripped. A housing coupled to the housing. The housing is structured to dispense a strap. A disk is coupled to the housing. The disk contains the strap. A stapler is coupled to the housing. The stapler selectively dispenses a staple from the housing. The strap is fastened to a support surface. A cutter is coupled to the housing. The cutter selectively cuts the strap after the strap is fastened to the support surface. A pair of actuators is coupled to the handle. The actuators are each electrically coupled to an associated one of the stapler and the cutter. The actuators each actuates the associated stapler and cutter.

### BACKGROUND OF THE DISCLOSURE

### Field of the Disclosure

The disclosure relates to strapping devices and more particularly pertains to a new strapping device for fastening a strap to a support surface.

### SUMMARY OF THE DISCLOSURE

An embodiment of the disclosure meets the needs presented above by generally comprising a handle may be gripped. A housing coupled to the housing. The housing is structured to dispense a strap. A disk is coupled to the housing. The disk contains the strap. A stapler is coupled to the housing. The stapler selectively dispenses a staple from the housing. The strap is fastened to a support surface. A cutter is coupled to the housing. The cutter selectively cuts the strap after the strap is fastened to the support surface. A pair of actuators is coupled to the handle. The actuators are each electrically coupled to an associated one of the stapler and the cutter. The actuators each actuates the associated stapler and cutter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a left side view of a strapping assembly according to an embodiment of the disclosure.

FIG. 2 is a perspective view of an embodiment of the disclosure.

FIG. 3 is a front view of an embodiment of the disclosure.

FIG. 4 is a cross sectional view taken along line 3-3 of FIG. 2 of an embodiment of the disclosure.

FIG. 5 is a left side cut-away view of an embodiment of the disclosure.

### DESCRIPTION OF THE PREFERRED EMBODIMENT

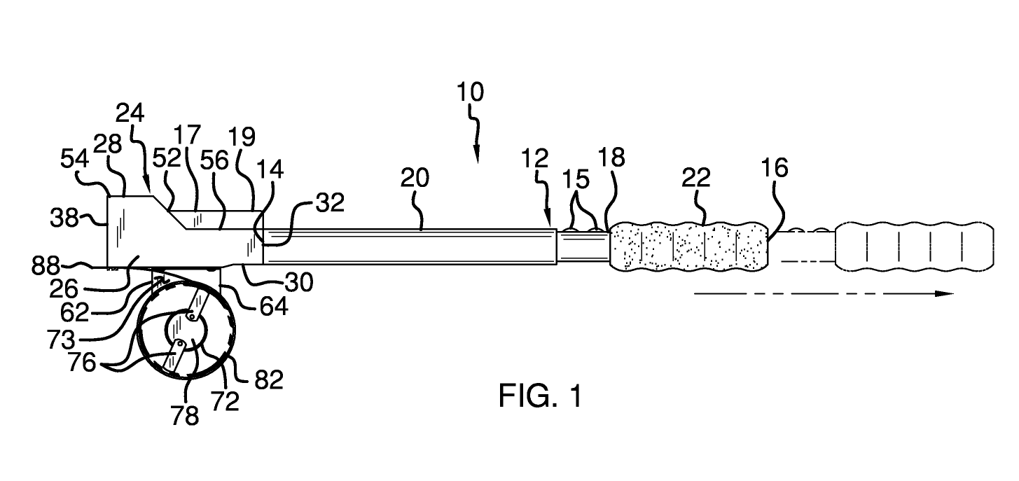

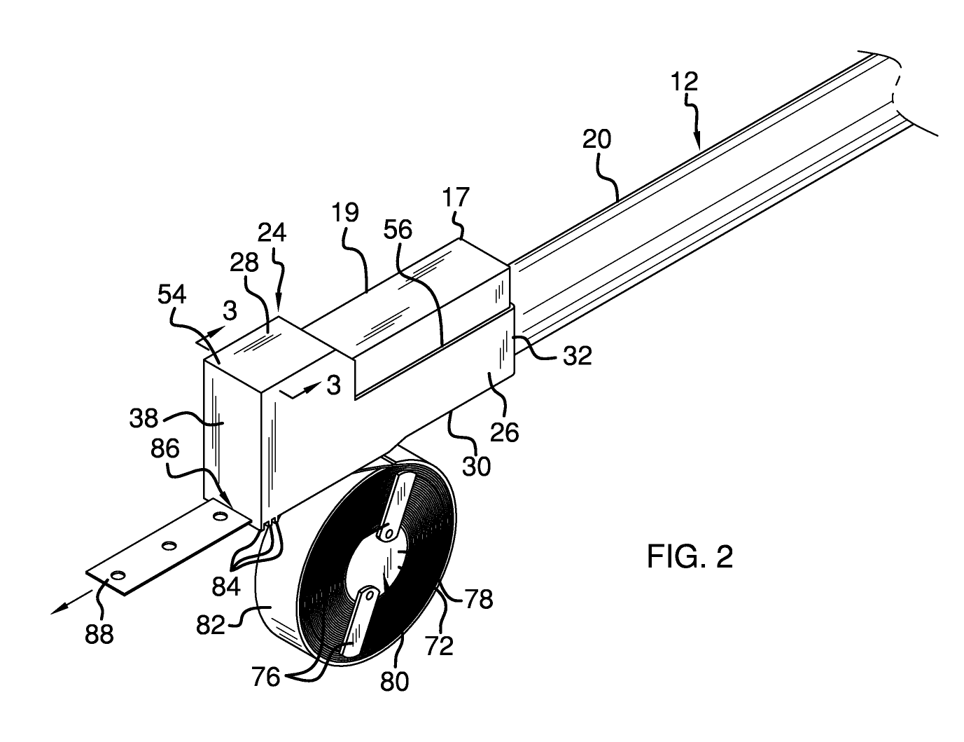

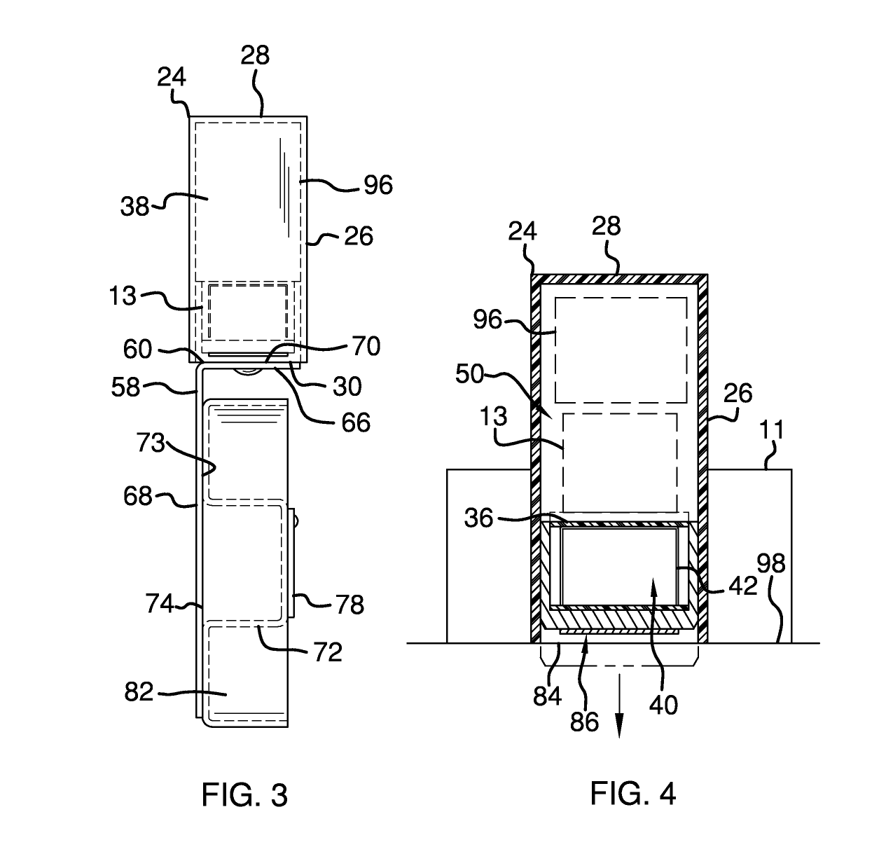

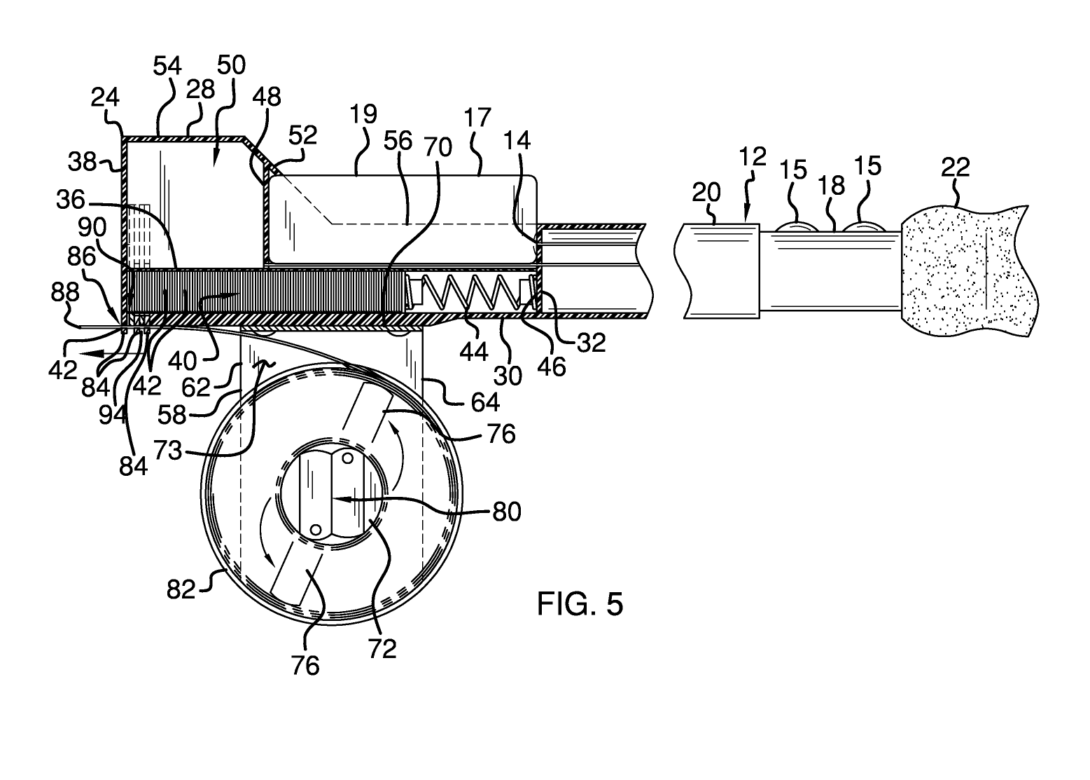

With reference now to the drawings, and in particular to FIGS. 1 through 5 thereof, a new strapping device embodying the principles and concepts of an embodiment of the disclosure and generally designated by the reference numeral 10 will be described.

As best illustrated in FIGS. 1 through 5, the strapping assembly 10 generally comprises a handle 12. The handle 12 has a first end 14 and a second end 16. Moreover, the handle 12 is elongated between the first 14 and second 16 ends. The handle 12 has a back portion 18 slidably coupled to a front portion 20 of the handle 12 so the handle 12 has a telescopically adjustable length. A grip 22 is coupled to the back portion 18 of the handle 12. The grip 22 extends forwardly from the second end 16 of the handle 12. The grip 22 may be gripped.

A housing 24 is provided. The housing 24 has an outer wall 26 extending between each of a top wall 28 and a bottom wall 30 of the housing 24. A back side 32 of the outer wall 26 of the housing 24 is coupled to the first end 14 of the front portion 20 of the handle 12. The housing 24 extends forwardly from the first end 14 of the front portion 20 of the handle 12.

The housing 24 has a first interior wall 36 coupled to and extending between a front side 38 and the back side 32 of the outer wall 26 of the housing 24. The first interior wall 36 defines a staple space 40 between the first interior wall 36 and the bottom wall 30 of the housing 24. Moreover, the staple space 40 may contain a plurality of staples 42. A spring biasing member 44 is coupled to an inside surface 46 of the back side 32 of the outer wall 26 of the housing 24. The spring biasing member 44 is positioned within the staple space 40. The spring biasing member 44 urges the staples 42 forwardly toward the front side 38 of the outer wall 26 of the housing 24.

The housing 24 has a second interior wall 48 coupled to and extending between the first interior wall 36 of the housing and the top wall 28 of the housing 24. The second interior wall 48 defines a stapler space 50 between the second interior wall 48 of the housing 24 and the front side 38 of the outer wall 26 of the housing 24. An angled portion 52 of the top wall 28 of the housing 24 angles downwardly between a forward portion 54 of the top wall 28 of the housing 24 and a rearward portion 56 of the top wall 28 of the housing 24.

A plate 58 is provided. The plate 58 has bend 60 extending between a front edge 62 and a back edge 64 of the plate 58 to define a coupled portion 66 and a free portion 68 of the plate 58. Additionally, the plate 58 has an L-shape. A top surface 70 of the coupled portion 66 of the plate 58 is coupled to the bottom wall 30 of the housing 24. The free portion 68 of the plate 58 extends downwardly from the bottom wall 30 of the housing 24.

A disk 72 is provided. A first oblique side 74 of the disk 72 is rotatably coupled to a first lateral surface 73 of the free portion 68 of the plate 58. A pair of arms 76 is coupled to a second oblique side 78 of the disk 72. The pair of arms 76 each extend away from a center 80 of the disk 72. A strap 82 is wrapped around the disk 72. The pair of arms 76 retain the strap 82 on the disk 72.

A plurality of tabs 84 is each coupled to and extends downwardly from the bottom wall 30 of the housing 24. The plurality of tabs 84 is evenly spaced apart and distributed rearwardly from the front side 38 of the outer wall 26 of the housing 24. Additionally, the plurality of tabs 84 each has a slot 86 extending therethrough. The slots 86 are aligned with each other so the strap 82 is extendable through the slots 86. A free end 88 of the strap 82 extends forwardly from the front side 38 of the outer wall 24 of the housing 22.

The bottom wall 30 of the housing 24 has a staple slot 90 extending therethrough. The staple slot 90 is positioned between a front one 92 and a middle one 94 of the plurality of tabs 84. A stapler 96 is coupled to the housing 22. The stapler 96 is positioned within the stapler space 50. Additionally, the stapler 96 may be an electric stapler of any conventional design.

The stapler 96 selectively dispenses the staples 42 through the staple slot 90. The staples 42 fasten the strap 82 to a support surface 98. The support surface 98 may be a ceiling. Additionally, the strap 82 may be used to secure an HVAC duct 11 to the support surface 98.

A cutter 13 is coupled to the housing 22. The cutter 13 is positioned within the stapler space 50. The cutter 13 selectively extends downwardly through the staple slot 90. The cutter 13 cuts the strap 82 after the strap 82 is fastened to the support surface 98. The cutter 13 may be an electrical cutter of any conventional design.

A pair of actuators 15 is coupled to the back portion 18 of the handle 12. The actuators 15 are positioned proximate the second end 16 of the handle 12. The actuators 15 are each electrically coupled to an associated one of the stapler 96 and the cutter 13. Moreover, the actuators 15 each actuates the associated stapler 96 and cutter 13.

A power supply 17 is removably coupled to the top wall 28 of the housing 22. The power supply 17 is positioned on the rearward portion 56 of the top wall 28 of the housing 22. Moreover, the power supply 17 is electrically coupled to the pair of actuators 15. The power supply 17 comprises at least one battery 19.

In use, the assembly 10 is utilized to secure HVAC duct 11 to the support surface 98. The strap 82 is manually extended outwardly from the front side 38 of the outer wall 24 of the housing 22. The stapler 96 is actuated to staple the strap 82 to the support surface 98. The cutter 13 is actuated after the HVAC duct 11 has been secured to the support surface 98. The assembly 10 allows the HVAC duct 11 to be secured single handedly.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A strapping assembly comprising:
a handle configured to be gripped;
a housing coupled to said housing, said housing being structured to dispense a strap;
a disk coupled to said housing such that said disk contains said strap;
a stapler coupled to said housing, said stapler selectively dispensing a staple from said housing such that said strap is fastened to a support surface;
a cutter coupled to said housing such that said cutter selectively cuts said strap after said strap is fastened to the support surface; and
a pair of actuators coupled to said handle, said actuators each being electrically coupled to an associated one of said stapler and said cutter such that said actuators each actuates said associated stapler and cutter.

2. The assembly according to claim 1, further comprising said handle having a first end and a second end, said handle being elongated between said first and second ends, said handle having a back portion slidably coupled to a front portion of said handle such that said handle has a telescopically adjustable length.

3. The assembly according to claim 2, further comprising said housing having an outer wall extending between each of a top wall and a bottom wall of said housing, a back side of said outer wall of said housing being coupled to said first end of said front portion of said handle such that said housing extends forwardly from said first end of said front portion of said handle.

4. The assembly according to claim 3, further comprising said housing having a first interior wall coupled to and extending between a front side and said back side of said outer wall of said housing such that said first interior wall defines a staple space between said first interior wall and said bottom wall of said housing wherein said staple space is configured to contain a plurality of the staples.

5. The assembly according to claim 4, further comprising said housing having a second interior wall coupled to and extending between said first interior wall of said housing and said top wall of said housing such that said second interior wall defines a stapler space between said second interior wall of said housing and said front side of said outer wall of said housing.

6. The assembly according to claim 5, further comprising:
a plurality of tabs each coupled to and extending downwardly from said bottom wall of said housing; and
said plurality of tabs being evenly spaced apart and distributed rearwardly from said front side of said outer wall of said housing.

7. The assembly according to claim 6, further comprising said plurality of tabs each having a slot extending therethrough, said slots being aligned with each other such that said strap is extendable through said slots wherein a free end of said strap extends forwardly from said front side of said outer wall of said housing.

6. The assembly according to claim 5, further comprising said stapler being positioned within said stapler space in said housing.

7. The assembly according to claim 5, further comprising said cutter being positioned within said stapler space in said housing.

8. The assembly according to claim 2, further comprising said actuators being coupled to said back portion of said handle such that said actuators are positioned proximate said second end of said handle.

9. The assembly according to claim 3, further comprising a power supply removably coupled to said top wall of said housing.

10. The assembly according to claim 8, further comprising said power supply being electrically coupled to said pair of actuators.

11. The assembly according to claim 10, further comprising said power supply comprising at least one battery.

12. A strapping assembly comprising:
a handle, said handle having a first end and a second end, said handle being elongated between said first and second ends, said handle having a back portion slidably coupled to a front portion of said handle such that said handle has a telescopically adjustable length;
a housing, said housing having an outer wall extending between each of a top wall and a bottom wall of said housing, a back side of said outer wall of said housing being coupled to said first end of said front portion of said handle such that said housing extends forwardly from said first end of said front portion of said handle;
said housing having a first interior wall coupled to and extending between a front side and said back side of said outer wall of said housing such that said first interior wall defines a staple space between said interior wall and said bottom wall of said housing wherein said staple space is configured to contain a plurality of staples;
said housing having a second interior wall coupled to and extending between said first interior wall of said housing and said top wall of said housing such that said second interior wall defines a stapler space between said second interior wall of said housing and said front side of said outer wall of said housing;
a plurality of tabs each coupled to and extending downwardly from said bottom wall of said housing, said plurality of tabs being evenly spaced apart and distributed rearwardly from said front side of said outer wall of said housing;
a disk rotatably coupled to said bottom wall of said housing, said disk containing a strap;
said plurality of tabs each having a slot extending therethrough, said slots being aligned with each other such that said strap is extendable through said slots wherein a free end of said strap extends forwardly from said front side of said outer wall of said housing;
a stapler coupled to said housing such that said stapler is positioned within said stapler space, said stapler selectively dispensing the staples from said housing such that said strap is fastened to a support surface;
a cutter coupled to said housing such that said cutter is positioned within said stapler space, said cutter selectively cutting said strap after said strap is fastened to the support surface;
a pair of actuators coupled to said back portion of said handle such that said actuators are positioned proximate said second end of said handle, said actuators each being electrically coupled to an associated one of said stapler and said cutter such that said actuators each actuates said associated stapler and cutter; and
a power supply removably coupled to said top wall of said housing, said power supply being electrically coupled to said pair of actuators, said power supply comprising at least one battery.
